(19) United States
(12) Patent Application Publication
(10) Pub. No.: US 2024/0044586 A1
(43) Pub. Date: Feb. 8, 2024

(54) Heating Panel, Treatment Apparatus, And Method For Treating Wood Material

(71) Applicant: Blokkwood GmbH, Hohenkammer (DE)

(72) Inventors: Janos Farkas, Szentendre (HU); Janos Roka, Budapest (HU)

(73) Assignee: Blokkwood GmbH, Hohenkammer (DE)

(21) Appl. No.: 18/487,528

(22) Filed: Oct. 16, 2023

Related U.S. Application Data
(63) Continuation of application No. PCT/HU22/50033, filed on Apr. 14, 2022.

(30) Foreign Application Priority Data
Apr. 15, 2021 (HU) P20100153

(51) Int. Cl. F28D 20/02; B30B 15/34

(52) U.S. Cl. CPC F28D 20/023; B30B 15/34

(57) ABSTRACT

The invention is a heating panel (10) for treating wood material (22), comprising
two boundary members (12) arranged parallel to each other, and
a heating wire (14) arranged between the boundary members (12).

The heating panel (10) is characterised in that
the heating panel (10) further comprises a solidified wood treatment composition (16) arranged between the boundary members (12) and surrounding the heating wire (14), and
the boundary members (12) are configured to allow the solidified wood treatment composition (16) to contact the wood material (22) to be treated.

The invention is furthermore a treatment apparatus (20), and a method for treating wood material (22).

### TECHNICAL FIELD

The invention relates to a heating panel, a treatment apparatus, and a method for treating wood material.

### BACKGROUND ART

It is well known that the lifetime of wood materials is greatly affected by their water uptake characteristics. Limiting the water uptake, or reducing the water uptake ability of the wood material fundamentally determines the lifetime and usability of the wood material, because the smaller the water uptake ability of the wood material, the lower its tendency to deform, warp and bloat due to water uptake, and the smaller its exposure to pests and fungal infections.

Wood materials typically contain 45-55% of cellulose, 20-35% of hemicellulose, 15-35% of lignin, and 1-10% of extract materials. Cellulose has various crystalline forms, e.g., cellulose I and cellulose II. Cellulose I only forms chains that are parallel with each other and are stabilised by hydrogen bonds. In the crystals of regenerated cellulose (cellulose II), the molecules have an alternating arrangement (i.e., are arranged in antiparallel positions). In nature and in natural wood materials, the overwhelming majority of cellulose is present as cellulose I, while the cellulose II form is present only in small amounts. Cellulose II can be typically produced by subjecting cellulose I to treatment with a concentrated base (>11-12%). The transition from cellulose I into cellulose II is irreversible, because cellulose II is thermodynamically more stable than cellulose I. Cellulose II provides a physically stronger and more stable structure, so it is preferable to apply such a modification of the wood material that transforms the natural cellulose I content of the wood material into cellulose II without damaging the wood material.

Due to its ordered structure, the cellulose contained in the wood material is not easily accessible to the various chemical agents applied in the course of a treatment process, so the molecular chain of the cellulose must preferably be “activated”, i.e., must be made accessible. Preferably, activation can be performed by applying water-soluble basic agents that are also able to modify the crystalline structure of cellulose.

Treatment with a base causes the following changes in the wood material. On the one hand, the basic environment bloats the cellulose and straightens its molecular chains to some extent, and therefore a stronger, physically more resistant material is produced, that has a brighter surface, while the resistance to pests and fungal infections of the wood material subjected to such a treatment also increases. On the other hand, the cellulose I contained by the wood material is transformed into cellulose II that lends a physically stronger and more stable structure to the wood material. As a result of the basic treatment, the cellulose would shrink, but, to a large extent this is prevented by the lignin and hemicellulose surrounding the grid structure of cellulose. By way of example, the basic treatment is carried out by boiling the cellulose with a base, which causes a shrinking of approximately 4%.

The above-described basic treatment was applied in the textile industry as early as in the 19th century (mercerization), but this method cannot be applied for treating wood material, as the bonded structure of the wood material does not allow this basic treatment to be carried out over the entire volume of the wood material, i.e., the above-described transformation cannot be performed in the wood material as a whole.

The prior art contains various technical solutions for treating wood material. The majority of the technical solutions for treating wood material is adapted for lengthening the lifetime of the wood material and the products made therefrom, and comprise, especially in the case of wood materials utilized outdoors, improving waterproofness, resistance to fungi and parasites, UV-resistance, and increasing load-bearing capacity, tensile strength, and hardness.

In the known treatment methods, wood material is usually treated with various chemical agents, for example by applying them to the surface of the wood material or soaking the wood in the agents, or even impregnating the wood material with the agent at high pressure. The disadvantage of these technical solutions is that the chemical agents applied for treatment can detach from the surface of the wood material during its use, or can be released therefrom into the environment, which in the case of certain chemicals can be dangerous to the environment, or to the health of the persons using the treated wood material or the products made therefrom.

Known treatment methods of wood materials include, among others, heat treatment, acetylation, and furfurylation.

Hungarian patent application P0800385 discloses a heat treatment method for treating wood material applying a sodium chloride catalyst.

HU 229 983 B1 discloses a composition for heat treatment of wood material, and a process for wood treatment. The composition comprises sodium chloride, an anticaking agent, a water absorbent/water release agent, and a filler material. In the course of the wood treatment process, a low oxygen environment must be generated for the wood material, which is achieved by completely covering the wood material with the treatment composition. Spacing between the pieces of wood material is also provided by the composition. With regard to the above, however, the implementation of the process is exceedingly difficult and time-consuming, and—if the application of human resources is involved—it is also costly, while the production of the composition itself is also cumbersome due to the great number of ingredients. Another disadvantage is that the wood material can be displaced and deformed during the heat treatment process, i.e., it may even emerge from under the composition providing the low oxygen environment.

GB 764,535 discloses a heating plate made from plywood, wherein a heating wire is introduced between plywood sheets, followed by assembling the components of the plate by gluing them together. The plywood is dried before assembly to prevent deformation under heating.

U.S. Pat. No. 3,659,077 discloses a solution for curing concrete, wherein the surface of the cast concrete is covered with a blanket comprising heating wires, establishing a direct contact between the heating element and the material to be heated.

EP 0 652 089 B1 discloses a method for treatment of wood material, particularly wooden beams, wherein the wood material is enveloped by electrical heating elements having an external surface having good heat insulating characteristics, and the wood material is heated to a temperature at which the parasites and pests in the wood material are destructed. The electrical heating elements are made from flexible sheets.

The documents cited below disclose further methods applied for the heat treatment of wood materials, and apparatus and system used for wood treatment, also including the arrangement of wood material for heat treatment processes.

US 2009/0220704 discloses a system for powder-coating MDF (medium density fibreboard) panels, or other products made of wood. The upper portion of the panels is secured to an overhead conveyor by hanger assemblies, followed by pre-heating the suspended wood material to 260-280° F. (approx. 126-138° C.) for 15-30 minutes, applying electrostatically charged powder to the panels that have a surface temperature of approx. 110-112° F. (43-44° C.), and finally treating the coating formed in such a manner for 30-45 minutes at a temperature of 300-330° F. (149-166° C.). The suspended panels are heated in ovens that are unable to provide uniform heating of the wood material.

U.S. Pat. No. 9,170,035 B2 discloses a method and apparatus for the thermo-transformation of wood material. The wood material produced applying the method is resistant to bio-degradation, insect damage, and rotting, and it also does not shrink, swell or warp. The wood material is treated without utilizing chemicals. The pieces of wood to be treated are mounted on a trolley such that they are spaced apart from each other and are introduced into the apparatus in a longitudinal direction.

US 2016/0354948 A1 discloses a method for modification and heating of wood material, wherein two different vessels are applied for heating the wood material and for modifying it by applying chemical agents. The wood material is arranged in the treatment apparatus in bundles, wherein the pieces of wood material in a bundle are either contacting each other or are spaced apart from each other by spacers. In the apparatus, the wood material is heated by applying microwave energy.

KR 10-1721797 B1 discloses an apparatus for drying wood material, wherein the wood material can be dried gently, i.e., without causing deformation. The pieces of wood material are introduced into the apparatus spaced apart from each other, such that the pieces can have a uniform drying: however, heaters are arranged in the sides of the apparatus. Heating applied from a lateral direction results in an uneven heat distribution, which does not allow the uniform drying of the wood material.

### DESCRIPTION OF THE INVENTION

In light of the known solutions, the is a need for a heating panel enabling that wood material can be subjected to heat treatment and can be treated with a treatment agent at the same time.

The object of the technical solution according to the invention is to provide a heating panel, a treatment apparatus, and a method for wood treatment that eliminate the drawbacks of prior art solutions to the greatest possible extent.

The primary object of the technical solution according to the invention is to provide a heating panel that is suitable for uniformly heating up wood material, for subjecting it to heat treatment and drying, and, simultaneously with the heat treatment, to treat the wood material with a treating agent.

Another object of the invention is to provide a treatment apparatus, wherein the treatment of the wood material can be performed safely, without endangering the environment and the health of the personnel operating the apparatus.

A further object of the invention is to provide a method that enables a uniform heat treatment and uniform drying of wood material.

The object according to the invention have been achieved by providing the heating panel according to claim 1, the treatment apparatus according to claim 8, and the method according to claim 14. Preferred embodiments of the invention are defined in the dependent claims.

The heating panel according to the invention has the advantage that the temperature of heating panels can be controlled individually if desired, so the heating panels can provide a customised heat treatment and drying for wood materials to be treated. Furthermore, the configuration of the heating panel enables the wood material to be treated to come into a direct contact with the treatment composition, which improves heat transfer—and thereby the efficiency of heat treatment—and also allows for performing an additional treatment in addition to heat treatment. Additional treatment is preferably manifested in that, when the wood material comes into contact with the treatment composition the treatment composition facilitates and controls the extraction of water held in the wood material, which increases the lifetime of the wood material, reduces the tendency of the wood material to bloat and shrink, and improves the protection of the wood material against parasites and fungal infections.

It has been recognised that by applying a solidified wood treatment composition, the composition adapted for wood treatment can be integrated into the heating panel, and, thanks to the heating panel, the wood material to be treated and the treatment composition can be brought into contact, and, after completing the treatment process, can be separated from each other, in a simpler and quicker manner.

A further advantage of the heating panel is that, thanks to its configuration, it prevents the wood material from being deformed/warped during the treatment process, and, as a result of the direct contact between the solidified wood treatment composition and the wood material to be treated, the composition is able to directly react with the wood material. A direct contact has the advantage that it is sufficient to apply a smaller quantity of treatment composition, which causes smaller mass loss, smaller shrinkage.

The treatment apparatus according to the invention has the advantage that the treatment of the wood material can be performed in a closed space, so harmful substances (for example dangerous chemicals) are not released into the environment, not even during the additional treatment applied in addition to heat treatment.

Furthermore, the treatment apparatus according to the invention is able to generate such an environment, preferably a low-oxygen environment, which facilitates that the cellulose I content of the wood material to be treated is transformed into cellulose II to a large extent, or even over the entire cross section of the wood material.

The method according to the invention has the advantage that, thanks to the direct contact between the wood material and the heating panel, a heat treatment that is more accurately controlled, more uniform, and more efficient than as of the existing solutions can be realized. In addition to heat treatment, the method according to the invention can also be applied for a controlled drying of the wood material. The drying process can be typically performed at lower temperatures compared to other wood treatment methods that are also adapted for modifying the structure of the wood material, so the treatment according to the invention causes a smaller modification of the colour of the wood material or no colour modification at all.

A further advantage of the method according to the invention is that it is also suitable for treating and drying wood material originating from freshly cut timber, i.e., wood material having a high moisture content, and that drying is carried out more quickly compared to prior art technical solutions. For example, of the conventional drying techniques, convection drying can be carried out typically in 5-45 days depending on the moisture content of the wood material, and even vacuum drying requires 3-9 days to complete. By applying the method according to the invention, however, the drying process of the wood material can be completed in at most 48 hours, or preferably even in 24 hours, which offers significant time saving and economic advantages.

The heating panel, treatment apparatus and method according to the invention have the advantage that the components of the solidified wood treatment composition are not incorporated into the wood material or are incorporated into it only to a small extent, so the treated wood material is not dangerous to the environment.

### BRIEF DESCRIPTION OF THE DRAWINGS

Preferred embodiments of the invention are described below by way of example with reference to the following drawings, where

FIG. 1 is a side view of a preferred embodiment of the heating panel according to the invention,

FIG. 2 is a sectional view of a preferred embodiment of the treatment apparatus according to the invention,

FIG. 3 is a detail view of another preferred embodiment of the treatment apparatus according to the invention,

FIG. 4A is a magnified side view of detail A of FIG. 3,

FIG. 4B is a magnified side view of detail B of FIG. 3, and

FIG. 5 is a sectional view of another preferred embodiment of the treatment apparatus according to the invention.

In the figures, components with like functions are denoted with the same reference numerals: however, their exact implementation—for example in different preferred embodiments—may vary.

### MODES FOR CARRYING OUT THE INVENTION

The heating panel 10 adapted for treating wood material 22 according to the invention comprises two parallelly arranged boundary members 12 having a shape that preferably corresponds to the shape of the wood material 22 to be treated, i.e., they preferably have a flat or curved configuration.

The heating panel 10 also comprises a heating wire 14 arranged between the two boundary members 12 that is preferably adapted for heating the wood material 22 to be treated that is brought into contact with the heating panel 10, i.e., subjecting it to a heat treatment.

The heating panel 10 further comprises a solidified wood treatment composition 16 that is arranged between the boundary members 12 and to surround the heating wire 14. The boundary members 12 are configured to allow the solidified wood treatment composition 16 to contact the wood material 22 to be treated. The boundary member 12 is preferably implemented as a perforated plate or grating that enables the solidified wood treatment composition 16 to contact the wood material 22 to be treated that is in contact with the heating panel 10. The boundary member 12 is preferably made of a heat-conducting material, for example metal, which improves heat transfer between the heating panel 10 and the wood material 22, thereby improving the heat treatment of the wood material 22.

The solidified wood treatment composition 16 preferably comprises a basic material, more preferably it comprises a strong base that has a swelling effect on the cellulose contained in the wood material 22. Strong bases are typically strong electrolytes that therefore dissociate completely. The basic material applied in the solidified wood treatment composition 16 can for example be LiOH, NaOH, KOH, RbOH, CsOH, Mg(OH)₂, Ca(OH)₂, Sr(OH)₂, Ba(OH)₂, Na₂S, or tetramethylammonium hydroxide (TMAH) which are all regarded as strong bases. The solidified wood treatment composition 16 may preferably comprise known compounds applied for chemical cooking. It is preferable that the basic material applied in the solidified wood treatment composition 16 does not melt and does not decompose under 300° C. It is particularly preferable to include NaOH in the solidified wood treatment composition 16, as the melting point and boiling point thereof is 318° C. and 1390° C., respectively.

The solidified wood treatment composition 16 preferably further comprises a heat conducting and heat retaining material that can be preferably selected from among the following materials:
various organic or inorganic salts, for example sulphates, chlorides, carbonates, acetates; salts of alkaline metals, for example sodium or potassium salts thereof; salts of alkaline earth metals, for example magnesium or calcium salts thereof;
silicates, silicate minerals;
oxide minerals, for example corundum (aluminium oxide), hematite (iron oxide), magnesium oxide; and
ground rock made from igneous rocks, for example granite, basalt, or andesite.

Preferably, the melting point of the heat conducting and heat retaining material is also higher than 300° C., and it also does not decompose under a temperature of 300° C. The heat conducting and heat retaining material preferably does not react with other components of the solidified wood treatment composition 16.

Especially preferable heat conducting and heat retaining materials are sodium chloride (melting point: 801° C., boiling point: 1465° C.), potassium chloride (melting point: 776° C., boiling point: 1500° C.), or sodium acetate (decomposes at 324° C.).

The solidified wood treatment composition 16 preferably further comprises at least 10% of a binder, that is adapted to contribute to the solidification of the solidified wood treatment composition 16 (i.e., to keep it in one bulk), and prevents the solidified wood treatment composition 16 from falling out through the gaps and holes of the boundary members 12, for example, in the case of boundary members 12 implemented as perforated plates, through the perforations, and in the case of boundary members 12 implemented as gratings, through the gaps of the grating. The binder is preferably a mineral adhesive. The binder is preferably a material that is permeable to vapour and moisture, or optionally a material that can absorb and later release moisture. Preferably, the following materials can be applied as a binder gypsum (CaSO₄), magnesium sulphate (MgSO₄), sodium sulphate (Na₂SO₄), or waterglass (aqueous solution of sodium silicate).

A preferred composition of the solidified wood treatment composition 16 is set forth in the example below.

### Example

15 wt % of sodium hydroxide as a basic material,
70 wt % of sodium chloride as a heat conducting and heat retaining material, and
15 wt % of waterglass as a binder.

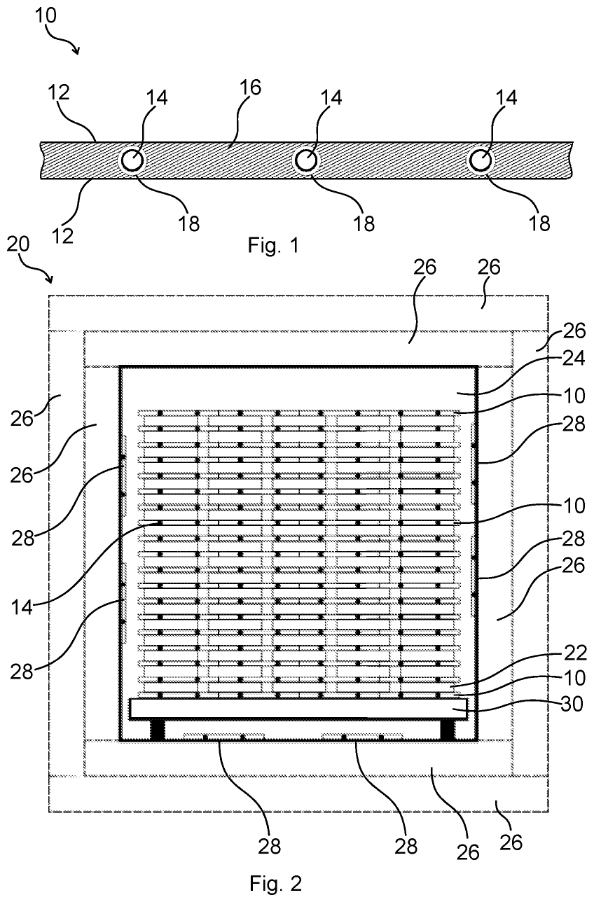

FIG. 1 illustrates a detail of a preferred configuration of the heating panel 10 according to the invention. The boundary members 12 of the heating panel 10 are arranged parallel to each other, and in the preferred embodiment according to FIG. 1 the boundary members 12 have a flat configuration, and three heating wires 14 are arranged between them in the detail shown in the figure, preferably at the same distance from each other. This arrangement facilitates a uniform heating (i.e., heat treatment) of the wood material 22 brought into contact with the heating panel 10. The heating wires 14 are preferably arranged at an identical distance from the boundary members 12, so in the arrangement according to the figure they are able to heat the wood material 22 to be heated, disposed above and under the heating panel 10, evenly, and to an identical extent. The heating wires 14 are preferably arranged inside a covering 18, wherein the covering 18 is preferably implemented as a tube, for example a metal tube, or a closed section having an arbitrary cross-sectional shape. The thickness of the heating panel 10, i.e., the distance between the boundary members 12, is preferably 10-100 mm. The length of the heating panel 10 is preferably 0.5-10 m, or preferably 1-5 m, and its width is preferably 0.2-5 m, or preferably 0.5-3 m. Smaller-sized heating panels 10 can even be moved without applying a lifting and/or moving apparatus, i.e., manually.

The boundary members 12 are preferably made from perforated sheet metal or grating, thereby enabling the solidified wood treatment composition 16 that is encompassed by the boundary members 12 and is arranged around the heating wires 14, and/or the covering 18 thereof to contact the wood material 22 to be treated that is brought into contact with the heating panel 10. Examples for preferred ways of contact between the wood material 22 to be treated and the heating panel 10 can be seen in FIGS. 2, 3, and 5.

The heating wires 14 are adapted for heating up the solidified wood treatment composition 16, that are able to directly heat, heat treat or dry the wood material 22 to be treated, and, if the applied boundary members 12 are made of a heat-conducting material, preferably metal, the solidified wood treatment composition 16 is also able to heat up the boundary members 12 that are also able to heat, heat treat or dry the wood material 22 to be treated.

The treatment apparatus 20 according to the invention, adapted for treating wood material 22, comprises a reaction space 24 configured for receiving the wood material 22 to be treated, and heating panels 10 arranged in the reaction space 24.

The treatment apparatus 20 preferably also comprises a press device adapted for pressing together the wood material 22 to be treated that is arranged in the reaction space 24 and the heating panel 10. The press device can preferably be a mechanical or hydraulic press.

In order to improve the heating and heat treatment of the wood material 22 to be treated, the reaction space 24 is preferably encompassed by thermal insulation members 26 that are adapted for reducing the heat loss of the reaction space 24.

Preferably, a heating member 28 adapted for heating the reaction space 24 is arranged along a wall (e.g., any bounding wall, for example a side wall, a ceiling and/or a floor) of the reaction space 24. The heating member 28 is preferably implemented as the heating panel 10 according to the invention.

FIG. 2 shows a sectional view of a preferred embodiment of the treatment apparatus 20 according to the invention. In the treatment apparatus 20 the heating panels 10 according to the invention and the wood material 22 to be treated are layered upon each other such that each piece of wood material 22 to be treated is arranged between two heating panels 10, and the wood material 22 to be treated is in contact with the boundary member 12 of the heating panel 10, and this way it is also in contact with the solidified wood treatment composition 16 of the heating panel 10.

In the treatment apparatus 20 according to FIG. 2, more than one pieces of wood material 22 are arranged in each layer, and the pieces in each layer are preferably having the same thickness, so the heating panels 10 are in contact with all of the pieces of wood material 22 of the given layer. The wood material 22 arranged in different layers may have different thicknesses. The wood material 22 can preferably be a trimmed or untrimmed board.

In the treatment apparatus 20 according to FIG. 2, the pieces of wood material 22 to be treated belonging to the same layer preferably do not contact each other, i.e., there is an air gap between the adjacently arranged pieces of wood material 22, through which the moisture extracted from the wood material 22 can be more easily discharged.

The size of the heating panels 10 applied in the treatment apparatus 20 preferably corresponds to the inside dimensions of the reaction space 24 of the treatment apparatus 20, i.e., the treatment apparatus 20 comprises one heating panel 10 for each layer. However, as can be seen in the preferred embodiment according to the figure, heating panels 10 of smaller size can also be applied, which can be tightly packed together. In the treatment apparatus 20 according to FIG. 2, four heating panels 10 are arranged in each layer, preferably in close contact with each other, and each heating panel 10 comprises two heating wires 14. In another preferred arrangement, the heating panels 10 are spaced apart from each other inside the layers, wherein the spacing between them is preferably 10-100 mm and is preferably the same as the thickness of the heating panel 10; this arrangement of the heating panels 10 preferably allows for more efficiently discharging the moisture extracted from the wood material 22. By applying smaller-sized heating panels 10, for example ones having a length of 1-2 m and a width of 20-100 cm, it has an advantage that the number and arrangement of the necessarily applied heating panels 10 can be changed flexibly, and that heating panels 10 with smaller size, and thus with lower mass, can be moved more easily (even manually), and they also allow for achieving better use of space in the reaction space 24.

The reaction space 24 of the treatment apparatus 20 can be preferably sealed hermetically, and a pressure lower than the atmospheric pressure can preferably be generated in the reaction space 24, which facilitates the extraction of moisture from the wood material 22. To improve the efficiency of moisture extraction, the treatment apparatus 20 can preferably also comprise a fan and/or an air heater.

The reaction space 24 of the treatment apparatus 20 is preferably enveloped by thermal insulation members 26 that preferably surround the reaction space 24 from all sides. In the preferred embodiment according to FIG. 2, the reaction space 24 is surrounded by two layers of thermal insulation members 26, thereby improving thermal insulation. The thermal insulation members 26 can be made of any thermal insulation material known from the prior art.

The treatment apparatus 20 preferably further comprises a heating member 28 that is preferably arranged along a wall of the reaction space 24, i.e., it is preferably arranged along a side wall, a ceiling, and/or a floor of the reaction space 24, and provides additional heating for the heat treatment of the wood material 22. The additional heating preferably contributes to providing a uniform temperature in the reaction space 24 of the treatment apparatus 20, and to equalizing occasional spatial differences in temperature, which provides that the entirety of the wood material 22 to be treated is at the same temperature, preferably also at such locations where it does not directly contact the heating panel 10. In the preferred embodiment according to FIG. 2, two respective heating members 28 are arranged along the walls and the floor of the reaction space 24. The heating member 28 can be implemented as any conventional component capable of heating, or the heating panel 10 can also be applied as a heating member 28. Preferably, such a panel can also be applied as a heating member 28 which does not comprise a solidified wood treatment composition 16, only heating wires 14.

In the preferred embodiment according to FIG. 2, the heating panels 10 and wood material 22 being stacked upon each other are arranged on a trolley 30 that can be preferably pushed into and pulled out from the reaction space 24. Thereby, the heating panels 10 and the wood material 22 can also be stacked upon each other and arranged outside the reaction space 24, followed by moving them into the reaction space 24. Instead of the trolley 30, another moving mechanism can also be applied, and the heating panels 10 and the wood material 22 can also be placed directly on the floor on the reaction space 24, or on a preferably fixed platform positioned thereon.

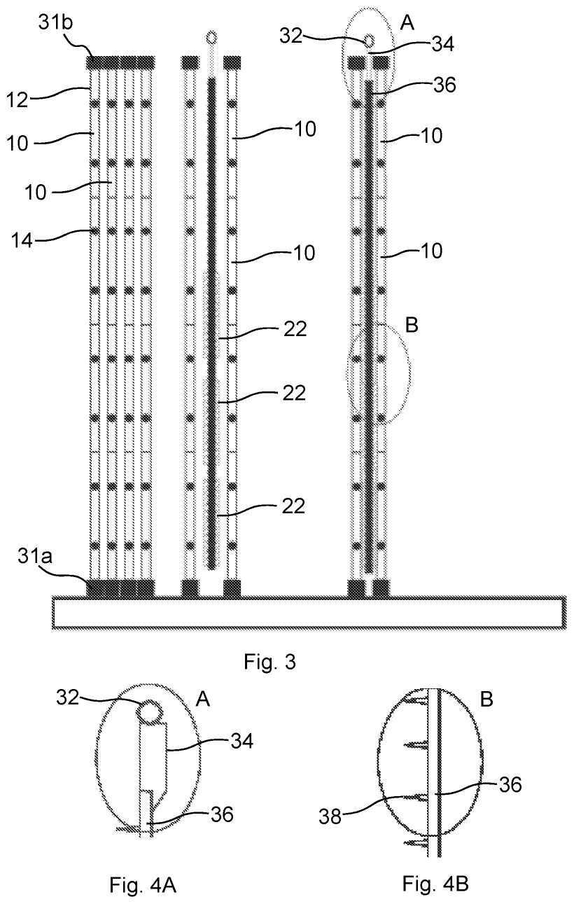

FIG. 3 shows a detail view of another preferred embodiment of the treatment apparatus 20 according to the invention. In this embodiment, the heating panels 10 are arranged vertically, and the wood material 22 to be treated is disposed between the vertically arranged heating panels 10. The heating panels 10 preferably comprise a bottom support member 31a and a top support member 31b that are adapted to ensure that the heating panel 10 is in a vertical position. The bottom support member 31a and the top support member 31b are preferably equipped with a moving mechanism that provides that the bottom support member 31a and the top support member 31b can move horizontally and thereby allows that the wood material 22 to be treated can be placed between the heating panels 10. The bottom support member 31a and the top support member 31b are preferably configured to comprise rollers. The configuration of the heating panels 10 preferably has the same features as were described above in relation to FIG. 1.

The position of the wood material 22 arranged between the heating panels 10 according to FIG. 3 can be fixed by applying a press device (not shown), or, alternatively, the wood material 22 can be affixed to a vertical support member 36. The vertical support member 36 is preferably also oriented vertically, and preferably comprises a fixing pin 38 (see FIG. 4B) adapted for securing the wood material 22. The vertical support member 36 can, on the one hand, be configured similarly to the bottom support member 31a and the top support member 31b of the heating panel 10, and, on the other hand, can have a configuration shown in FIG. 3, wherein the vertical support member 36 is affixed to a hanger member 32 via a coupling member 34. For a more detailed configuration of the hanger member 32 and the coupling member 34 see FIG. 4A. The hanger member 32 can be preferably moved along a guide member, for example a bar or rail, or can be hung on a hook that can be moved along a guide member. Accordingly, the wood material 22 affixed to the vertical support member 36 can be placed between the heating panels 10 and can be preferably pressed together therewith by applying a press device.

The wood material 22 to be treated is preferably arranged—for example, fixed to the vertical support member 36—in the treatment apparatus 20 according to FIG. 3 in a manner that corresponds to the growth and grain direction of the wood material 22 to be treated, i.e., the portion of the wood material 22 to be treated that originally lays closer to the roots is arranged at the bottom. It is of common knowledge that living trees have channels that transport water taken up by the tree from the roots towards the foliage. These channels are typically located in the sapwood (albumum) layer of the tree which surrounds in an annular manner the older, inner portion of the tree's body, the heartwood (duramen). As the tree gets older, the cells engaged in water transport die and are transformed into solid wood (heartwood), while the task of transporting water is taken over by a newly grown sapwood layer. Although the heartwood is no longer engaged in transporting water, water and other mineral materials are stored in the cell walls of the heartwood layer, for example in a bound state. The quantity of water stored in the heartwood layer preferably depends on the equilibrium values of various parameters (for example, pressure, temperature, etc.). In the case of the above-described preferred arrangement, the internal water (or optionally, nutrient) transport channels of the wood material 22 can be utilized in the course of the treatment process of the wood material 22 for discharging the water contained in the wood material 22 and the water vapour generated from the water under the effect of heat. During the wood treatment process, the water contained in the wood or the water vapour can be extracted along the channels of the wood material 22 with a lower flow resistance.

The treatment apparatus 20 according to FIG. 3 has the advantage that, thanks to the vertical (e.g., suspended) arrangement, the treatment apparatus 20 is able to perform a simultaneous treatment of a given quantity of wood material 22 in a reduced floor space, which reduces operating costs and improves space utilization.

FIG. 4A shows a magnified side view of detail A of FIG. 3, illustrating in more detail the interconnection of the hanger member 32, the coupling member 34, and the vertical support member 36. The features of the hanger member 32, the coupling member 34, and the vertical support member 36 are identical to the features explained in relation to FIG. 3.

FIG. 4B shows a magnified side view of detail B of FIG. 3. In FIG. 4B there can be observed the fixing pins 38 arranged on the vertical support member 36 that are adapted for fixing the wood material 22 to the vertical support member 36. The fixing pins 38 are preferably evenly spaced apart along the vertical support member 36.

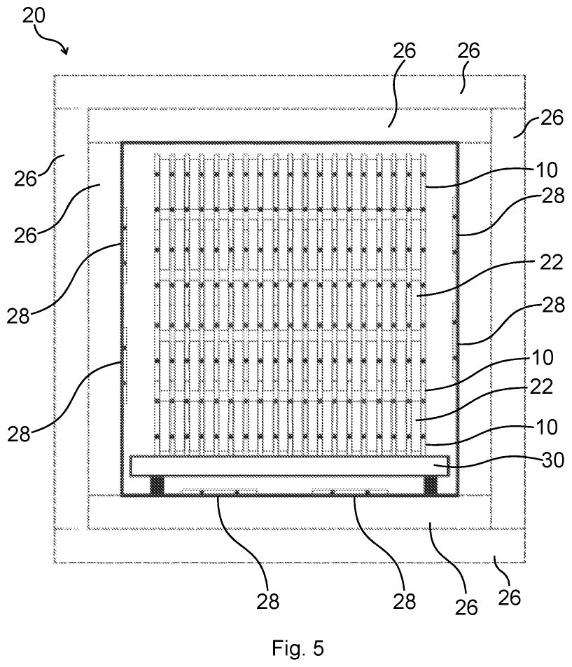

FIG. 5 shows a sectional view of a further preferred embodiment of the treatment apparatus 20 according to the invention. The heating panels 10 and the pieces of wood material 22 to be treated, which are preferably pressed together by applying a press device (not shown in the drawing), are stacked with a vertical orientation beside each other also in the treatment apparatus 20 according to FIG. 5. In the embodiment according to FIG. 5, the heating panels 10 and the wood material 22 to be treated are rotated by 90 degrees with respect to the arrangement according to FIG. 3. The further structural components of the treatment apparatus 20 according to FIG. 5 and their features and alternatives are preferably identical to the structural components according to FIG. 3 and their features and alternatives.

The invention further relates to a method for treating wood material 22 comprising the step of subjecting the wood material 22 to be treated to heat treatment. In the course of the heat treatment process, the moisture content of the wood material 22 to be treated is removed in such a manner that it not only does not damage the wood material 22 but brings about advantageous changes in the wood material 22, for example increases the resistance and strength of the wood material 22. For performing the heat treatment, the wood material 22 to be treated is brought into contact with the heating panel 10 according to the invention, and the heat required for the heat treatment is at least partially provided by heating up the heating wire 14 disposed in the heating panel 10. By contacting the heating panel 10, the wood material 22 to be treated also comes into contact with the solidified wood treatment composition 16 of the heating panel 10. In the course of the method, the wood material 22 to be treated is preferably arranged between two heating panels 10, and, to prevent the deformation (warping) of the wood material 22 during the treatment, the wood material 22 and the heating panel 10 are pressed together. Heat treatment is preferably performed in a hermetically sealed reaction space 24, preferably in the reaction space 24 of the treatment apparatus 20 according to the invention, at a pressure that is lower than the atmospheric pressure, and preferably at a temperature of 20-300° C., more preferably at a temperature of 100-220° C., for a duration of 6-48 hours. The applied pressure—that is lower than the atmospheric pressure (i.e., underpressure)—is preferably lower than the atmospheric pressure by at most 10,000 Pa.

At the preferred temperature of 100-220° C. the bound and free water content of the wood material 22 to be treated is transformed into vapour or steam and is thus able to leave the wood material 22, for example by diffusing from the intercellular space towards the surface of the wood material 22. Water condensing on the surface of the wood material 22 is also transformed into water vapour. When the temperature is raised above 100° C., a superheated, saturated, wet steam space is produced in the reaction space 24, in which the ratio of water and vapour can be adjusted, and the equilibrium of water and vapour can be maintained and controlled by controlling the pressure inside the reaction space 24. With raising external temperature and raising the temperature of the wood material 22, the fibre saturation limit decreases, and thereby the equilibrium moisture content of the wood material 22 is also reduced, which urges the water to leave the wood material 22. The moisture content of the medium, e.g., air or gas, surrounding the wood material 22 can be adjusted by quickly removing the generated vapour, and also by the introduction of a dry medium. These actions change the partial pressure of the vapour in the wood material 22, which results in water and water vapour being extracted from the wood material 22, thereby contributing to the drying of the wood material 22.

It is preferred to increase the temperature of the wood material 22 to be treated gradually (i.e., in stages) during the process, which contributes to a gentle treatment and drying of the wood material 22 and reduces the occurrence of tensions in the wood material 22 and the chance of warping of the wood material 22.

By applying pressure control, it is also possible to prevent a vapour explosion from occurring in the wood material 22, for example in the wood fibres thereof. In order to maintain an equilibrium, water supplied preferably from an external source can be injected to the reaction space 24 in addition to applying pressure control.

In order to introduce the solidified wood treatment composition 16 of the heating panel 10 into the wood material 22, it is preferred to intermittently increase the humidity, even to 100%, more preferably to apply a slight overpressure, preferably an overpressure of at most 10,000 Pa. Pressure can be controlled for example by applying a fan and/or air heater arranged in the treatment apparatus 20.

The method may optionally comprise a preparation, for example cutting to size or trimming of the wood material 22.

In the course of performing the treatment method, the heat treatment can preferably also be carried out according to a predetermined program, for example a temperature-time function.

The treatment method is preferably performed in a low-oxygen environment. To provide such an environment, the reaction space 24 of the treatment apparatus 20 is filled with a protective gas, which protective gas is for example nitrogen, carbon dioxide, or a mixture thereof. The advantage of low-oxygen environments is that the spontaneous ignition or self-ignition of the wood material 22 can be prevented.

In the course of the method according to the invention the relative moisture content of the wood material 22 can be reduced under 5% by the end of the treatment process. The moisture content of the wood material 22 is preferably continuously being measured and monitored during the course of the treatment process, and the predetermined heat treatment program can be modified based on the measured data.

During the treatment method according to the invention, the pressure of the reaction space 24 is controlled preferably according to a predetermined pressure profile, which pressure profile contains pressure values that are higher than the atmospheric pressure by at most 10,000 Pa and are lower than the atmospheric pressure by at most 10,000 Pa. The pressure of the reaction space 24 of the treatment apparatus 20 is preferably being monitored during the whole course of the treatment process, preferably by using pressure sensors arranged in the reaction space 24. In a preferred embodiment of the invention, the predetermined pressure profile provides that a predetermined pressure value is maintained, wherein the predetermined pressure value is for example the atmospheric pressure: the pressure sensors can also be applied for monitoring and maintaining this predetermined pressure value.

The manner of industrial application of the invention follows from the features of the technical solution according to the disclosure above. As can be seen from the description above, the invention achieves its objectives in a very advantageous manner compared to the prior art. The invention is, of course, not limited to the preferred embodiments described in detail above, but further variants, modifications and developments are possible within the scope of protection determined by the claims.

### LIST OF REFERENCE SIGNS

10 heating panel
12 boundary member
14 heating wire
16 solidified wood treatment composition
18 covering
20 treatment apparatus
22 wood material
24 reaction space
26 thermal insulation member
28 heating member
30 trolley
31a bottom support member
31b top support member
32 hanger member
34 coupling member
36 vertical support member
38 fixing pin

1. A heating panel (10) for treating wood material (22), comprising
two boundary members (12) arranged parallel to each other, and
a heating wire (14) arranged between the boundary members (12),
characterised in that
the heating panel (10) further comprises a solidified wood treatment composition (16) arranged between the boundary members (12) and surrounding the heating wire (14), and
the boundary members (12) are configured to allow the solidified wood treatment composition (16) to contact the wood material (22) to be treated.

2. The heating panel (10) according to claim 1, characterised in that the boundary member (12) is a perforated plate or grating.

3. The heating panel (10) according to claim 1, characterised in that the boundary member (12) is made of a heat conducting material.

4. The heating panel (10) according to claim 1, characterised in that the solidified wood treatment composition (16) comprises a basic material, the basic material being LiOH, NaOH, KOH, RbOH, CsOH, Mg(OH)₂, Ca(OH)₂, Sr(OH)₂, Ba(OH)₂, Na₂S, or tetramethylammonium hydroxide (TMAH).

5. The heating panel (10) according to claim 1, characterised in that the solidified wood treatment composition (16) comprises a heat conducting and heat retaining material and at least 10 wt % of a binder.

6. The heating panel (10) according to claim 5, characterised in that the heat conducting and heat retaining material is a metal salt, preferably an alkaline metal salt or alkaline earth metal salt, a silicate or silicate mineral, an oxide mineral, or ground rock made from igneous rock.

7. The heating panel (10) according to claim 5, characterised in that the binder comprises gypsum, magnesium sulphate, sodium sulphate, or waterglass.

8. A treatment apparatus (20) for treating wood material (22), comprising a hermetically sealable reaction space (24) configured for receiving the wood material (22) to be treated,
characterised by further comprising
heating panels (10) according to claim 1 arranged in the reaction space (24).

9. The treatment apparatus (20) according to claim 8, characterised in that it comprises a press device pressing together the wood material (22) to be treated arranged in the reaction space (24) and the heating panel (10).

10. The treatment apparatus (20) according to claim 8, characterised in that the reaction space (24) is surrounded by a thermal insulation member (26).

11. The treatment apparatus (20) according to claim 8, characterised in that a heating member (28) heating the reaction space (24) is arranged along a wall of the reaction space (24).

12. The treatment apparatus (20) according to claim 11, characterised in that the heating member (28) is arranged on a side wall, a ceiling, or a floor of the reaction space (24).

13. The treatment apparatus (20) according to claim 11, characterised in that the heating member (28) is the heating panel (10) according to claim 1.

14. A method for treating wood material, comprising subjecting the wood material (22) to be treated to heat treatment, characterised by further comprising the steps of bringing the wood material (22) to be treated into contact with the heating panel (10) according to claim 1, and providing the heat required for the heat treatment by heating the heating wire (14) arranged in the heating panel (10).

15. The method according to claim 14, characterised by arranging the wood material (22) to be treated between two heating panels (10).

16. The method according to claim 14, characterised by pressing together the wood material (22) to be treated and the heating panel (10).

17. The method according to claim 14, characterised by performing the heat treatment in a hermetically sealed reaction space (24), in the reaction space (24) of the treatment apparatus (20) according to claim 8 at a pressure that is lower than the atmospheric pressure.

18. The method according to claim 14, characterised by performing the heat treatment at a temperature of 20-300° C., preferably at a temperature of 100-220° C., for a duration of 6-48 hours.
